(19) United States
(12) Patent Application Publication
(10) Pub. No.: US 2018/0285812 A1
(43) Pub. Date: Oct. 4, 2018

(54) PACKAGE TRACKING

(71) Applicant: Walmart Apollo, LLC, Bentonville, AR (US)

(72) Inventor: Douglas E. Humphrys, Bentonville, AR (US)

(21) Appl. No.: 15/944,151

(22) Filed: Apr. 3, 2018

Related U.S. Application Data
(60) Provisional application No. 62/480,925, filed on Apr. 3, 2017.

(51) Int. Cl. G06Q 10/08; G06Q 30/00; G06Q 30/06; G06K 19/07

(52) U.S. Cl. CPC G06Q 10/0833; G06K 19/0707; G06Q 30/0639; G06Q 30/016

(57) ABSTRACT

Methods and systems for facilitating package tracking are provided. A method may include, in response to activation of a piezoelectric RFID tag coupled to a customer order package, transmitting a signal from the piezoelectric RFID tag, the signal including customer order information. The method may further include receiving, at a first RFID reader at a retail store, the signal from the piezoelectric RFID tag including the customer order information. The method may also include logging, based on receiving of the signal from the piezoelectric RFID tag at the first RFID reader, the customer order package as having an arrived status at a customer order package server in communication with the first RFID reader. The method may additionally include, in response to logging the customer order package as having the arrived status at the customer order package server, transmitting a customer order notification to a customer.

### RELATED APPLICATIONS

This application claims the benefit of U.S. Provisional Patent Application No. 62/480,925, filed Apr. 3, 2017 and entitled “Package Tracking”, the contents of which are incorporated herein in their entirety.

### TECHNICAL FIELD

The technical field may generally relate to tracking packages, and more particularly to tracking packages with RFID tags.

### BACKGROUND

A company or business may allow customers to purchase products online, on the Internet, and/or via a mobile device. The customer may go to a retail location, store, or distribution center of the company or business and may pick up the product or a package or box which may contain or include the product. Upon arrival at the retail location, for example, an employee or associate of the company or business may ask for purchase information or customer information from the customer in order to determine which package is for the customer and where the package might be. This process may be time consuming, as the employee or associate may need to physically go to a backroom or warehouse area of the retail location to find the package or may need to contact another employee or associate to find the package. Thus, there may be a need for methods and systems which facilitate tracking packages and/or package locations.

### BRIEF SUMMARY

In an embodiment, a method for facilitating automated checkout is provided. The method may include, in response to activation of a piezoelectric RFID tag coupled to a merchandise item, transmitting a signal from the piezoelectric RFID tag, the signal including merchandise item information. The method may further include receiving, at a passive RFID reader, the signal from the piezoelectric RFID tag including the merchandise item information. The method may also include determining, based on detection of the signal from the piezoelectric RFID tag including the merchandise item information at the passive RFID reader, whether the merchandise item should be added to an electronic shopping cart. The method may additionally include, in response to determining that the merchandise item should be added to the electronic shopping cart, adding the merchandise item to the electronic shopping cart based on the merchandise item information.

In an implementation, the method may include determining, based on a change in detection of the signal from the piezoelectric RFID tag at the passive RFID reader, whether the merchandise item should be removed from the electronic shopping cart. The method may further include, in response to determining that the merchandise item should be removed from the electronic shopping cart, removing the merchandise item from the electronic shopping cart. The method may also include, monitoring content of the electronic shopping cart to determine whether a plurality of merchandise items coupled to piezoelectric RFID tags should be added or removed from the electronic shopping cart based on detection of signals from the piezoelectric RFID tags. The method may additionally include concluding a transaction for the merchandise item based on the electronic shopping cart.

In an implementation, the piezoelectric RFID tag may be powered by a piezoelectric film. The passive RFID reader may be coupled to at least one of a shopping cart, a shopping basket, a wearable item, and a mobile device. The passive RFID reader may be arranged to detect RFID signals within at least one of a shopping cart and a shopping basket based on a passive RFID reader parameter. The electronic shopping cart may be a component of a mobile application running on a mobile device. The transaction may be concluded in response to determining that a customer associated with the electronic shopping cart has left a store. The transaction may be concluded by deducting credit from a customer account associated with the electronic shopping cart.

In an embodiment, a system for facilitating automated checkout is provided. The system may include a piezoelectric RFID tag coupled to a merchandise item and powered in response to movement. The system may further include a passive RFID reader in communication with a device having an electronic shopping cart component. The passive RFID reader may be arranged to detect a signal from the piezoelectric RFID tag coupled to the merchandise item.

In an implementation, the piezoelectric RFID tag may be powered by a piezoelectric film. The passive RFID reader may be coupled to at least one of a shopping cart, a shopping basket, a wearable item, and a mobile device. The passive RFID reader may be arranged to detect RFID signals within at least one of a shopping cart and a shopping basket based on a passive RFID reader parameter. The electronic shopping cart may be a component of a mobile application running on a mobile device.

In an embodiment, a system for facilitating automated checkout at a retail store is provided. The system may include a plurality of piezoelectric RFID tags and a plurality merchandise items. Each of the plurality of piezoelectric RFID tags may be coupled to a different one of the plurality of merchandise items in a one to one correspondence and may be powered in response to movement. A passive RFID reader may be coupled to at least one of a shopping cart, a shopping basket, a wearable item, and a mobile device. The passive RFID reader may be in communication with a device having an electronic shopping cart component. The passive RFID reader may be arranged to detect a signal from each of the plurality of piezoelectric RFID tags. A mobile self-checkout system may be operable to receive transaction data from the device having the electronic shopping cart.

In an embodiment, a method for facilitating automated checkout is provided. The method may include determining, at a computing device, that a customer having a retail store mobile application account has entered a retail store based on a signal received from a mobile device. The method may further include determining whether a merchandise item should be added to an electronic shopping cart associated with the retail store mobile application account. The method may also include, in response to determining that the merchandise item should be added to the electronic shopping cart, adding, at the computing device, the merchandise item to the electronic shopping cart. The method may additionally include determining, at the computing device, that the customer having the retail store mobile application account has left the retail store based on a change in the signal received from the mobile device. Moreover, the method may include, in response to determining that the customer has left the retail store, concluding a transaction for the merchandise item based on the electronic shopping cart. In an implementation, determining whether the merchandise item should be added to the electronic shopping cart may include receiving, at a passive RFID reader, a signal from a piezoelectric RFID tag coupled to the merchandise item.

In an embodiment, a computer program product residing on a computer readable storage medium may have a plurality of instructions stored thereon, which, when executed by a processor, may cause the processor to perform operations for facilitating automated checkout. The operations may include, in response to activation of a piezoelectric RFID tag coupled to a merchandise item, transmitting a signal from the piezoelectric RFID tag, the signal including merchandise item information. The operations may further include receiving, at a passive RFID reader, the signal from the piezoelectric RFID tag including the merchandise item information. The operations may also include determining, based on detection of the signal from the piezoelectric RFID tag including the merchandise item information at the passive RFID reader, whether the merchandise item should be added to an electronic shopping cart. The operations may additionally include, in response to determining that the merchandise item should be added to the electronic shopping cart, adding the merchandise item to the electronic shopping cart based on the merchandise item information.

In an embodiment, a computing system for facilitating automated checkout, may include one or more processors. The one or more processors may be configured to, in response to activation of a piezoelectric RFID tag coupled to a merchandise item, transmit a signal from the piezoelectric RFID tag, the signal including merchandise item information. The one or more processors may be further configured to receive, at a passive RFID reader, the signal from the piezoelectric RFID tag including the merchandise item information. The one or more processors may also be configured to determine, based on detection of the signal from the piezoelectric RFID tag including the merchandise item information at the passive RFID reader, whether the merchandise item should be added to an electronic shopping cart. The one or more processors additionally be configured to, in response to determining that the merchandise item should be added to the electronic shopping cart, add the merchandise item to the electronic shopping cart based on the merchandise item information.

In an embodiment, a method for tracking customer order packages may include, in response to activation of a piezoelectric RFID tag coupled to a customer order package, transmitting a signal from the piezoelectric RFID tag, the signal including customer order information. The method may further include receiving, at a first RFID reader at a retail store, the signal from the piezoelectric RFID tag including the customer order information. The method may also include logging, based on receiving of the signal from the piezoelectric RFID tag at the first RFID reader, the customer order package as having an arrived status at a customer order package server in communication with the first RFID reader. The method may additionally include, in response to logging the customer order package as having the arrived status at the customer order package server, transmitting a customer order notification to a customer associated with the customer order information indicating that the customer order package arrived at the retail store.

In an implementation, the method may include logging a location status for the customer order package at the customer order package server in communication with the first RFID reader based on a location of the first RFID reader. The method may further include updating the location status for the customer order package at the customer order package server in response to receiving the signal including the customer order information at a second RFID reader at the retail store, based on a location of the second RFID reader. The piezoelectric RFID tag may be powered by a piezoelectric film. The first RFID reader may be at least one of a passive RFID reader and a semi-passive RFID reader. The first RFID reader may be arranged to detect RFID signals reaching a geo-fence of the retail store.

In an implementation, the method may include monitoring, via a plurality of RFID readers at the retail store, changes in location of the customer order package by receiving the signal including the customer order information at the plurality of RFID readers and logging a location status for the customer order package at the customer order package server based on a location of each of the plurality of RFID readers at the retail store. The location status for the customer order package at the customer order package server may indicate a shelf location of the customer order package in the retail store. The customer order notification may be transmitted to a mobile device associated with the customer. The method may further include transmitting the location status for the customer order package from the customer order package server to a point of sale system at the retail store, the location status for the customer order package based on the location of the second RFID reader.

In an embodiment, a system for tracking customer order packages may include a piezoelectric RFID tag coupled to a customer order package and powered in response to movement. The system may further include a RFID reader at a retail store in communication with a customer order package server. The RFID reader may be positioned in the retail store to provide a location status of the customer order package to the customer order package server in response to receiving a signal from the piezoelectric RFID tag coupled to the customer order package.

In an implementation, the piezoelectric RFID tag may be powered by a piezoelectric film. The RFID reader may be at least one of a passive RFID reader and a semi-passive RFID reader. The RFID reader may be arranged to detect RFID signals reaching a geo-fence of the retail store. The system may further include a plurality of RFID readers at the retail store positioned to monitor changes in location of the customer order package by receiving a signal including customer order information from the piezoelectric RFID tag coupled to the customer order package at the plurality of RFID readers and transmit a location status for the customer order package to the customer order package server based on a location of each of the plurality of RFID readers at the retail store. The system may also include a point of sale system in communication with the customer order package server positioned to receive the location status of the customer order package from the customer order package server, the location status for the customer order package based on the location of the RFID reader.

In an embodiment, a system for tracking customer order packages may include a plurality of piezoelectric RFID tags and a plurality of customer order packages, each of the plurality of piezoelectric RFID tags coupled to a different one of the plurality of customer order packages in a one to one correspondence and powered in response to movement. The system may further include a plurality RFID readers at the retail store positioned to monitor changes in location of the plurality of customer order packages by receiving signals including customer order information from each of the plurality of piezoelectric RFID tags coupled to the different customer order packages at the plurality of RFID readers and transmit location statuses for the customer order packages to the customer order package server based on locations of each of the plurality of RFID readers at the retail store. The system may also include a point of sale system in communication with the customer order package server positioned to receive the location statuses of the customer order packages from the customer order package server, the location statuses for the customer order packages based on the locations of each of the plurality of RFID readers at the retail store.

In an embodiment, a computer program product residing on a computer readable storage medium may have a plurality of instructions stored thereon, which, when executed by a processor, may cause the processor to perform operations for facilitating packing tracking. The operations may include, in response to activation of a piezoelectric RFID tag coupled to a customer order package, transmitting a signal from the piezoelectric RFID tag, the signal including customer order information. The operations may further include receiving, at a first RFID reader at a retail store, the signal from the piezoelectric RFID tag including the customer order information. The operations may also include logging, based on receiving of the signal from the piezoelectric RFID tag at the first RFID reader, the customer order package as having an arrived status at a customer order package server in communication with the first RFID reader. The operations may additionally include, in response to logging the customer order package as having the arrived status at the customer order package server, transmitting a customer order notification to a customer associated with the customer order information indicating that the customer order package arrived at the retail store.

In an embodiment, a computing system for facilitating package tracking is provided. The computing system may include one or more processors, wherein the one or more processors may be configured to, in response to activation of a piezoelectric RFID tag coupled to a customer order package, transmit a signal from the piezoelectric RFID tag, the signal including customer order information. The one or more processors may be further configured to receive, at a first RFID reader at a retail store, the signal from the piezoelectric RFID tag including the customer order information. The one or more processors may also be configured to log, based on receiving of the signal from the piezoelectric RFID tag at the first RFID reader, the customer order package as having an arrived status at a customer order package server in communication with the first RFID reader. The one or more processors may additionally be configured to, in response to logging the customer order package as having the arrived status at the customer order package server, transmit a customer order notification to a customer associated with the customer order information indicating that the customer order package arrived at the retail store.

The details of one or more implementations are set forth in the accompanying drawings and the description below. Other features and advantages will become apparent from the description, the drawings, and the claims.

### BRIEF DESCRIPTION OF THE DRAWINGS

FIG. 1 depicts an example system that can execute implementations of the present disclosure;

FIG. 2 illustrates an example process for facilitating automated checkout in accordance with the present disclosure;

FIG. 3 depicts example components of a system for facilitating automated checkout in accordance with the present disclosure; and

FIG. 4 depicts an example electronic shipping cart in accordance with the present disclosure;

FIG. 5 illustrates an example process for tracking packages in accordance with the present disclosure;

FIG. 6 depicts example components of a system for tracking packages in accordance with the present disclosure; and

FIG. 7 illustrates an example process for tracking packages in accordance with the present disclosure.

### DETAILED DESCRIPTION

### Overview

Multiple cashiers and/or store associates and various point of sale equipment such as cash registers or computing devices may be required to handle a high volume of customers checking out at a retail store or otherwise concluding purchase transactions, all of which may be expensive for a retail store or business selling products. The retail store or business may implement methods and systems described in the present disclosure which facilitate a more automated checkout system, in order to increase efficiency and reduce costs.

Further, customers picking up preordered products/packages (e.g., ordered over the Internet) may go to a retail store location or distribution center to pick up a package and may spend time at the retail store location or distribution center waiting for an employee or associate to retrieve the package from a backroom or warehouse section of the retail store location or distribution center. The company or business operating the retail store location or distribution center may implement methods and systems described in the present disclosure which may facilitate tracking packages for easier locating and retrieval of the packages at the retail store location or distribution center.

Systems and methods to facilitate automated checkout and/or package tracking may be provided in the present disclosure and may use passive, semi-passive, and/or piezoelectric radio frequency identification (RFID) tags and/or readers and electronic shopping carts.

An RFID tag may store information electronically and may be attached or coupled to an item, such as a product or package at a store or distribution center. The information stored in the RFID tag may be useful for identifying the item or information about the item. An RFID reader may include a transmitter, receiver, and/or transceiver and may transmit a signal to an RFID tag or receive a signal from the RFID tag. The RFID tag may be passive or active. A passive RFID tag may be powered by energy transmitted by the RFID reader while an active RFID tag may be powered by its own battery. The RFID reader may also be passive or active. A passive RFID reader may receive signals from an active (self-powered) RFID tag while an active RFID reader may transmit signals in order to activate a passive RFID tag. The active RFID reader may then receive response signals from the passive RFID tag, once the passive RFID tag has been activated.

An active RFID reader may require a relatively substantial power source in order to activate a passive RFID tag. A passive RFID reader may require less power and avoid inclusion of a heavy power source for reader. A small, portable RFID tag can be discrete and cheap. For example, an RFID tag may be powered by piezoelectric component or device such that when moved, the RFID tag is powered and transmits a signal. The signal may include information about an item coupled to the RFID tag.

In various implementations of the present disclosure, an RFID tag may be powered by a piezoelectric component. The piezoelectric component may include a crystal, ceramic and/or film material or any substance which, when moved, deformed and/or pressured, produces an electric charge. The electric charge may be used to power the RFID tag when moved, and the RFID tag may then transmit a signal which may be received by an RFID reader.

Items for sale in a retail store or packages to be picked up at a retail store or distribution center may be equipped with RFID tags. One problem with active RFID tags implemented in this manner may be that each RFID tag transmits signals constantly. This may create a high amount of signal traffic in a store or distribution center with many items or packages and may require significant amounts of power in aggregate. Passive RFID tags implemented in this manner may require less power but may also require an active RFID reader in order to activate each passive RFID tag. This may require a significant amount of power as well, because the active RFID reader may also need to transmit signals constantly, and may also need to transmit signals with enough power to activate the RFID tags.

In an embodiment, items for sale in a retail store may be equipped with piezo-electrically powered RFID tags. An advantage of using piezo-electrically powered RFID tags is that these RFID tags may only be powered upon being moved. For example, and shopper may place an item in a cart. The movement of piezo-electrically powered RFID tag coupled to the item caused by the shopper placing the item in the cart may activate an electric charge in the piezo-electrically powered RFID tag which may activate the piezo-electrically powered RFID tag to transmit a signal including information about the item. The signal may be received by a passive RFID reader in or nearby the cart and the item may be added to an electric shopping cart for purchase. As a result, piezoelectric RFID tags may be used in electronic or smart cart applications in order to facilitate automatic checkout.

Further, in an embodiment, packages sent to and received at a retails tore location or distribution center may be equipped with piezo-electrically powered RFID tags. An advantage of using piezo-electrically powered RFID tags is that these RFID tags may only be powered upon being moved. For example, an employee or store associate may place a package on a shelf in a backroom or warehouse area. The movement of piezo-electrically powered RFID tag coupled to the package caused by the employee or store associate placing the package on the shelf may activate an electric charge in the piezo-electrically powered RFID tag which may activate the piezo-electrically powered RFID tag to transmit a signal including information about the package. The signal may be received by a passive RFID reader on or nearby the shelf and the package may be logged into a package tracking system or server as being located on that particular shelf. As a result, piezoelectric RFID tags may be used in computerized package tracking applications in order to facilitate package tracking and identifying the location of a particular package.

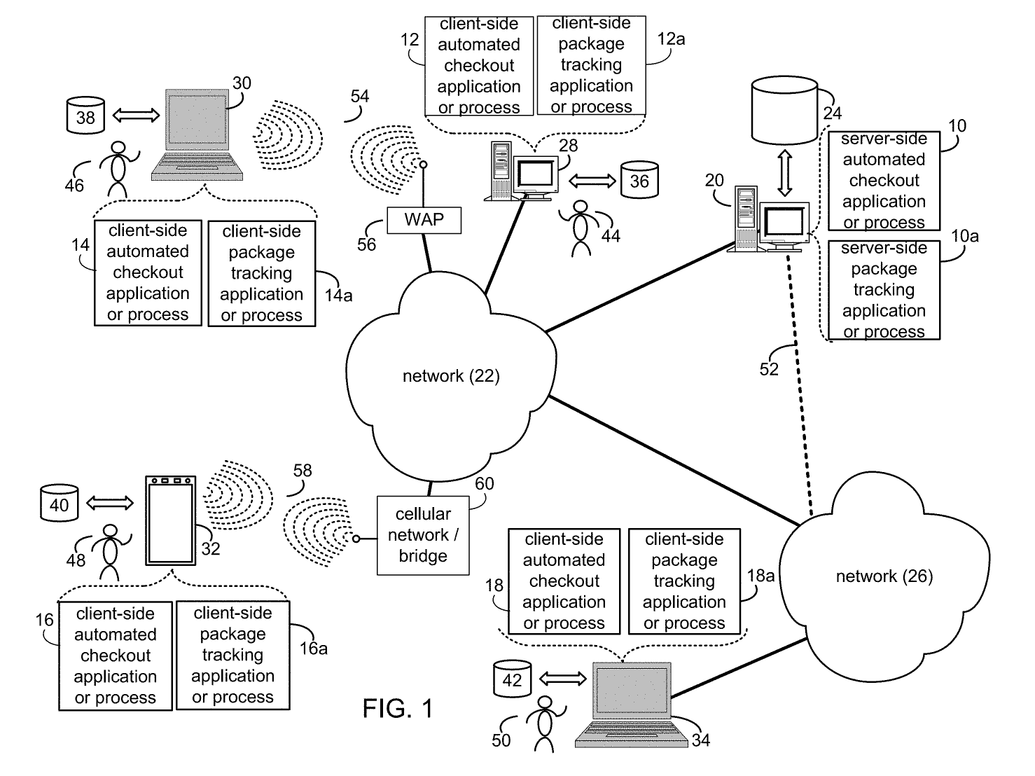

Referring to FIGS. 1, 2, and 5, there is shown server applications 10 and 10a and client applications 12, 14, 16, and 18 and 12a, 14a, 16a, and 18a. Server applications 10 and 10a and/or one or more of client applications 12, 14, 16, and/or 18 and 12a, 14a, 16a, and/or 18a may execute one or more processes configured to carry out one or more of the features described herein. Server application 10 may be referred to as a process configured to carry out one or more of the features described herein, such as automated checkout process 10. Further, one or more of client applications 12, 14, 16, and 18 may be referred to as a process configured to carry out one or more of the features described herein, such as automated checkout processes 12, 14, 16, and/or 18. Further, server application 10a may be referred to as a process configured to carry out one or more of the features described herein, such as package tracking process 10a. Further, one or more of client applications 12a, 14a, 16a, and 18a may be referred to as a process configured to carry out one or more of the features described herein, such as package tracking processes 12a, 14a, 16a, and/or 18a.

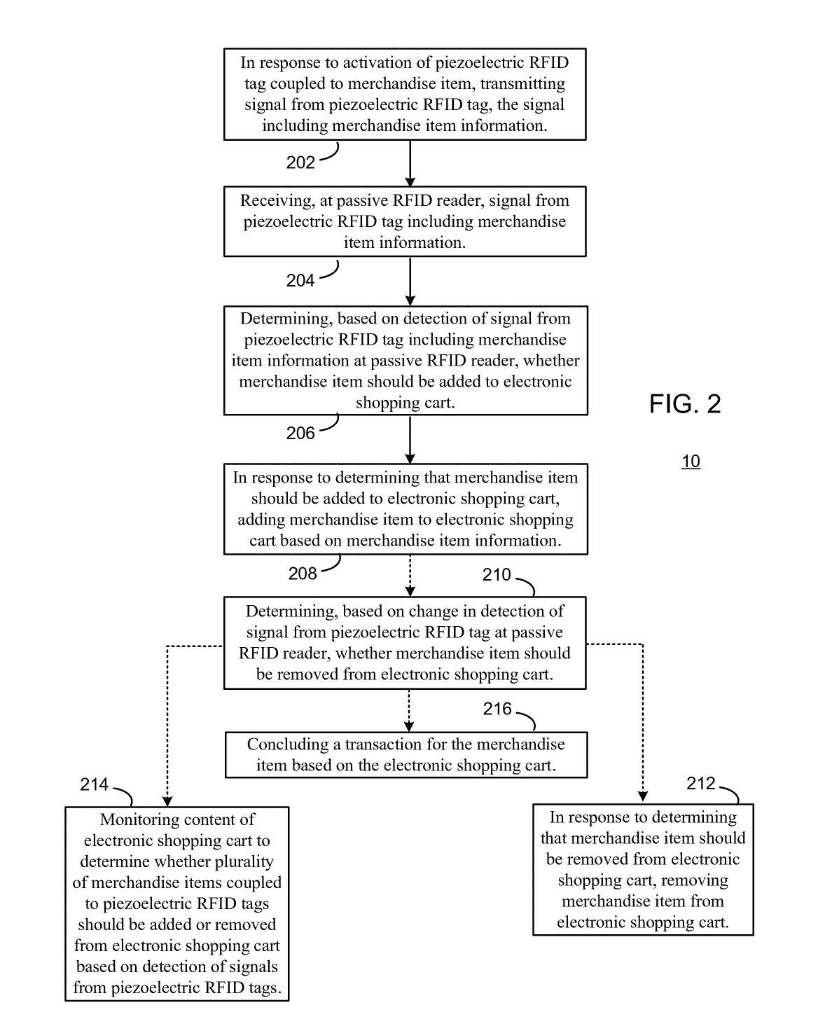

Referring now to FIG. 2, an example automated checkout process 10 is shown. Automated checkout process 10 may, in response to activation of a piezoelectric RFID tag coupled to a merchandise item, transmit (202) a signal from the piezoelectric RFID tag, the signal including merchandise item information. Automated checkout process 10 may further include receiving (204) at a passive RFID reader, the signal from the piezoelectric RFID tag including the merchandise item information. Automated checkout process 10 may also include determining (206) based on detection of the signal from the piezoelectric RFID tag including the merchandise item information at the passive RFID reader, whether the merchandise item should be added to an electronic shopping cart. Automated checkout process 10 may additionally, in response to determining that the merchandise item should be added to the electronic shopping cart, add (208) the merchandise item to the electronic shopping cart based on the merchandise item information.

The automated checkout process may be a server-side process (e.g., server-side automated checkout process 10), a client-side process (e.g., client-side automated checkout process 12, client-side automated checkout process 14, client-side automated checkout process 16, or client-side automated checkout process 18), or a hybrid server-side/client-side process (e.g., a combination of server-side automated checkout process 10 and one or more of client-side automated checkout processes 12, 14, 16, 18).

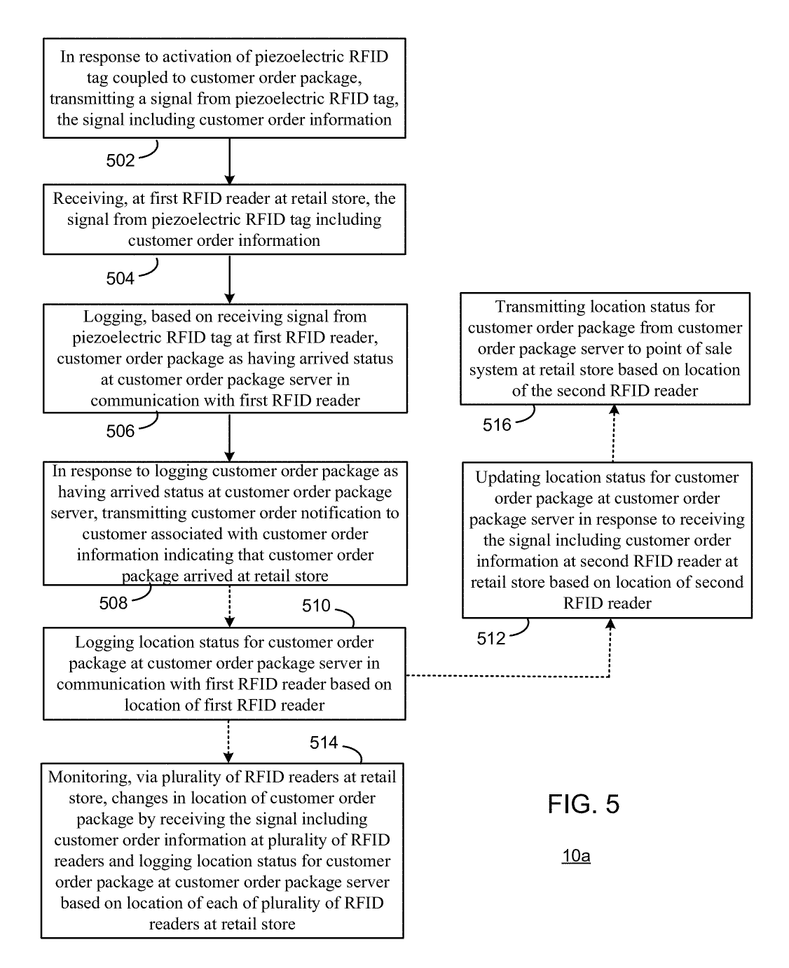

Referring now to FIG. 5, an example package tracking process 10a is shown. Package tracking process 10a may, in response to activation of a piezoelectric RFID tag coupled to a customer order package, transmit (502) a signal from the piezoelectric RFID tag, the signal including customer order information. Package tracking process 10a may further receive (504), at a first RFID reader at a retail store, the signal from the piezoelectric RFID tag including the customer order information. Package tracking process 10a may also log (506), based on receiving of the signal from the piezoelectric RFID tag at the first RFID reader, the customer order package as having an arrived status at a customer order package server in communication with the first RFID reader. Package tracking process 10a may additionally, in response to logging the customer order package as having the arrived status at the customer order package server, transmit (508) a customer order notification to a customer associated with the customer order information indicating that the customer order package arrived at the retail store.

The package tracking process may be a server-side process (e.g., server-side package tracking process 10a), a client-side process (e.g., client-side package tracking process 12a, client-side package tracking process 14a, client-side package tracking process 16a, or client-side package tracking process 18a), or a hybrid server-side/client-side process (e.g., a combination of server-side package tracking process 10a and one or more of client-side package tracking processes 12a, 14a, 16a, 18a).

### System Overview

Referring to FIG. 1, server-side automated checkout process 10 and/or server-side package tracking process 10a may reside on and may be executed by server computer 20, which may be in communication with network 22 (e.g., the Internet or a local area network). Examples of server computer 20 may include, but are not limited to: a personal computer, a server computer, a series of server computers, a mini computer, and/or a mainframe computer. The server computer 20 may be a distributed system and the operations of server computer 20 may execute on one or more processors, simultaneously and/or serially. For example, server computer 20 may be a symbolic representation of a cloud computing site, cloud environment, or cloud platform running multiple servers, computers, or virtual machines. Server computer 20 may execute one or more operating systems, examples of which may include but are not limited to: Microsoft Windows Server™; Novell Netware Redhat Linux™, Unix, or a custom operating system, for example.

For example, server computer 20 may be a symbolic representation of a cloud-based automated checkout system, cloud-based package tracking system, or server suitable for performing the operations described in the present disclosure. In an implementation, server computer 20 may be a cloud-based automated checkout system and/or cloud-based package tracking system or server which may include, store, run, and/or execute automated checkout process 10 and/or package tracking process 10a. The cloud-based automated checkout system and/or cloud-based package tracking system, or server may be part of a network of servers and other computing devices administered by a company or business that uses automated checkout process 10 and/or package tracking process 10a, such as a retailer or physical store selling products to customers.

The instruction sets and subroutines of server-side automated checkout process 10 and/or package tracking process 10a, which may be stored on storage device 24 coupled to server computer 20, may be executed by one or more processors (not shown) and one or more memory architectures (not shown) incorporated into server computer 20. Storage device 24 may include but is not limited to: a hard disk drive; a tape drive; an optical drive; a solid state storage device; a RAID array; a random access memory (RAM); and a read-only memory (ROM).

Server computer 20 may execute a web server application that allows for access to server computer 20 (via network 22) using one or more protocols, examples of which may include but are not limited to HTTP (i.e., HyperText Transfer Protocol). Network 22 may be in communication with one or more secondary networks (e.g., network 26), examples of which may include but are not limited to: a local area network; a wide area network; or an intranet, for example.

Client-side automated checkout processes 12, 14, 16, 18 and/or client-side package tracking processes 12a, 14a, 16a, 18a may reside on and may be executed by client electronic devices 28, 30, 32, and/or 34 (respectively), examples of which may include but are not limited to personal computer 28, a television with one or more processors embedded therein or coupled thereto (not shown), laptop computer 30, data-enabled mobile telephone or smartphone 32, notebook computer 34, a tablet (not shown), and a personal digital assistant (not shown), for example. Client electronic devices 28, 30, 32, and/or 34 may each be in communication with network 22 and/or network 26 and may each execute an operating system, examples of which may include but are not limited to Apple iOS™, Microsoft Windows™, Android™, Redhat Linux™, or a custom operating system.

In an implementation, one or more of client electronic devices 28, 30, 32, and/or 34 may be associated with an associate, employee, or customer of the company or business that uses one or more of automated checkout process 10, 12, 14, 16, 18 and/or package tracking processes 10a, 12a, 14a, 16a, and/or 18a such as a retailer or physical store having customers. For example, data-enabled mobile telephone 32 may be a mobile device such as a smartphone associated with the associate, employee, or customer.

The instruction sets and subroutines of client-side automated checkout processes 12, 14, 16, 18 and/or client-side package tracking processes 12a, 14a, 16a, 18a which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; solid state storage devices; RAID arrays; random access memories (RAM); read-only memories (ROM); compact flash (CF) storage devices; secure digital (SD) storage devices; and memory stick storage devices.

Client-side automated checkout processes 12, 14, 16, 18 and/or server-side automated checkout process 10 may be processes that run within (i.e., are part of) a cloud computing site, cloud computing application, cloud platform, or cloud environment. Alternatively, client-side automated checkout processes 12, 14, 16, 18 and/or server-side automated checkout process 10 may be stand-alone applications that work in conjunction with the cloud computing site, cloud computing application, cloud platform, or cloud environment. One or more of client-side automated checkout processes 12, 14, 16, 18 and server-side automated checkout process 10 may interface with each other (via network 22 and/or network 26). Further, client-side package tracking processes 12a, 14a, 16a, 18a and/or server-side package tracking process 10a may be processes that run within (i.e., are part of) a cloud computing site, cloud computing application, cloud platform, or cloud environment. Alternatively, client-side package tracking processes 12a, 14a, 16a, 18a and/or server-side package tracking process 10a may be stand-alone applications that work in conjunction with the cloud computing site, cloud computing application, cloud platform, or cloud environment. One or more of client-side package tracking processes 12a, 14a, 16a, 18a and/or server-side package tracking process 10a may interface with each other (via network 22 and/or network 26).

Users 44, 46, 48, 50 may access server-side automated checkout process 10 and/or server-side package tracking process 10a directly through the device on which the client-side automated checkout process or client-side package tracking process (e.g., client-side automated checkout processes 12, 14, 16, 18 and/or client-side package tracking processes 12a, 14a, 16a, 18a) is executed, namely client electronic devices 28, 30, 32, 34, for example. Users 44, 46, 48, 50 may access server-side automated checkout process 10 and/or server-side package tracking process 10a directly through network 22 and/or through secondary network 26. Further, server computer 20 (i.e., the computer that executes server-side automated checkout process 10 and/or server-side package tracking process 10a) may be in communication with network 22 through secondary network 26, as illustrated with phantom link line 52.

The various client electronic devices may be directly or indirectly coupled to network 22 (or network 26). For example, personal computer 28 is shown directly coupled to network 22 via a hardwired network connection. Further, notebook computer 34 is shown directly coupled to network 26 via a hardwired network connection. Laptop computer 30 is shown wirelessly coupled to network 22 via wireless communication channel 54 established between laptop computer 30 and wireless access point (i.e., WAP) 56, which is shown directly coupled to network 22. WAP 56 may be, for example, an IEEE 802.11a, 802.11b, 802.11g, 802.11n, Wi-Fi, and/or Bluetooth device that is capable of establishing a wireless communication channel 54 between laptop computer 30 and WAP 56. Data-enabled mobile telephone 32 is shown wirelessly coupled to network 22 via wireless communication channel 58 established between data-enabled mobile telephone 32 and cellular network/bridge 60, which is shown directly coupled to network 22.

All of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth is a telecommunications industry specification that allows e.g., mobile phones, computers, and personal digital assistants to be interconnected using a short-range wireless connection.

### Automated Checkout Process

For the following discussion, server-side automated checkout process 10 will be described for illustrative purposes. It should be noted that server-side automated checkout process 10 may interact with client-side automated checkout process 12 and may be executed within one or more applications that allow for communication with client-side automated checkout process 12. However, this is not intended to be a limitation of this disclosure, as other configurations are possible (e.g., stand-alone, client-side automated checkout processes and/or stand-alone server-side automated checkout processes). For example, some implementations may include one or more of client-side automated checkout processes 12, 14, 16, and/or 18 in place of or in addition to server-side automated checkout process 10. Further, all or parts of automated checkout process 10 and/or automated checkout processes 12, 14, 16, and/or 18 may be run or executed in a point of sale environments.

As discussed above RFID tags may require batteries and power which may be costly. Prices associated with individual RFID tags powered with batteries or even passively powered may very expensive due to those power sources or corresponding RFID readers. Piezoelectric RFID tags may be much cheaper because they may not require batteries and may utilize piezoelectric power sources such as piezoelectric films. By coupling piezoelectric RFID tags with products for sale at a store, various issues associated with RFID tagging everything in the store (e.g., too many signals being transmitted at the same time, RFID readers receiving too many signals, battery cost, etc.) may be avoided and automated checkout may be facilitated while decreasing costs.

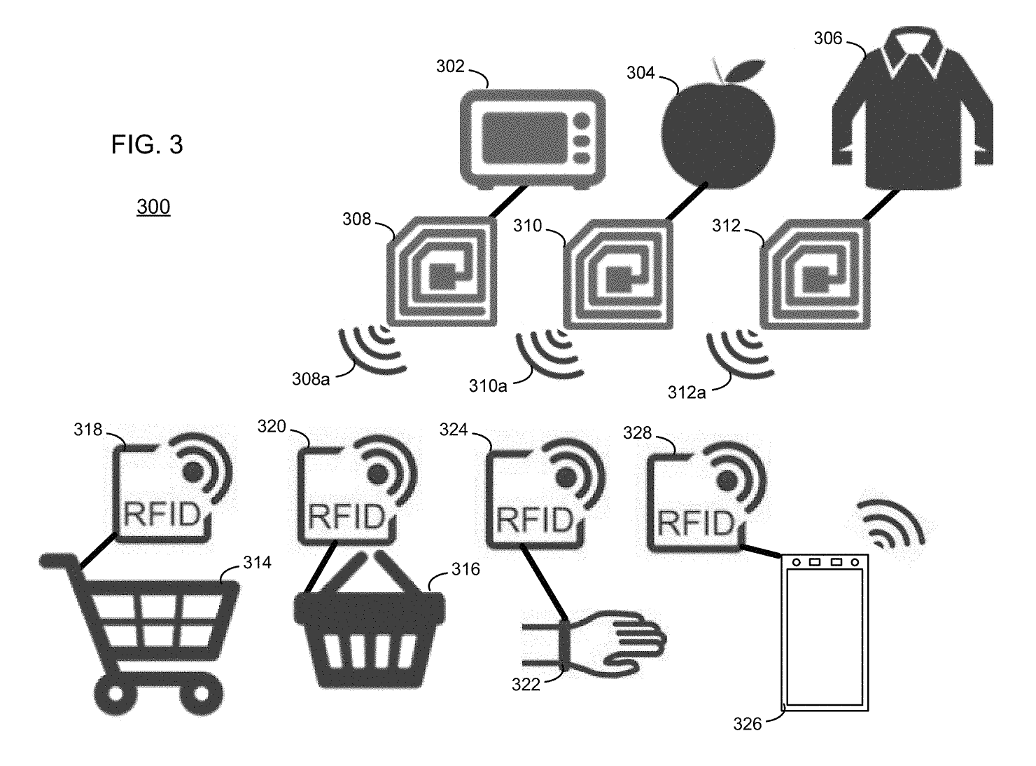

Referring now to FIG. 3, example components of a system 300 for facilitating automated checkout are shown. For example, merchandise items or products 302, 304, and 306 may be coupled to piezoelectric RFID tags 308, 310, and 312, respectively. As discussed above, piezoelectric RFID tags 308, 310, and 312 may be powered in response to movement. Passive RFID readers may be coupled to a shopping cart, a shopping basket, a wearable item, and/or a mobile device, among other objects. For example, shopping cart 314 and shopping basket 316 may be coupled to or associated with RFID readers 318 and 320, respectively. Wearable device 322 may be coupled to or associated with RFID reader 324. Smartphone 326 may include an RFID reader 328, which may be a component of smartphone 326 or otherwise be associated with smartphone 326. One or more of the passive RFID readers may be coupled to a computing device having an electronic shopping cart component or application. Further, one or more of the passive RFID readers may be arranged to detect a signal from one or more of piezoelectric RFID tags 308, 310, and 312, coupled to merchandise items or products 302, 304, and 306, respectively.

In this way, system 300 may include a plurality of piezoelectric RFID tags (e.g., piezoelectric RFID tags 308, 310, and 312) and a plurality merchandise items (e.g., products 302, 304, and 306). Each of the plurality of piezoelectric RFID tags may be coupled to a different one of the plurality of merchandise items in a one to one correspondence and may be powered in response to movement. The products and components shown in FIG. 3 may be part of an example shopping environment at a retail store which implements example system 300 and the techniques and features described in the present disclosure to facilitate automated checkout. In an implementation, hundreds or thousands of products in a store or business may be coupled with piezo-electronic RFID tags to facilitate automated checkout as described herein.

Referring also to FIG. 2, in an embodiment, methods for facilitating automated checkout may be provided and may be implemented via automated checkout process 10. In an embodiment, automated checkout process 10 may, in response to activation of a piezoelectric RFID tag (e.g., piezoelectric RFID tags 308, 310, or 312) coupled to a merchandise item (e.g., products 302, 304, or 306), transmit (202) a signal. The signal (e.g., signal 308a, 310a, or 312a) may be an RFID signal and may include information about the merchandise item such as a product code or number, price, etc. For example, if a customer picks up product 302, piezoelectric RFID tag 308 may be activated and may transmit RFID signal 308a (which may include merchandise item information).

It should be noted that use of piezoelectric RFID tags 308, 310, or 312 or other piezo-electrically powered RFID tags rather than active or even some passive RFID tags on multiple products (in, e.g., a retail store environment) may avoid the situation where multiple RFID signals are constantly sent in the shopping environment. By using piezo-electrically powered RFID tags, corresponding RFID signals may only be transmitted when the products (and RFID tags coupled thereto) are moved. Each piezoelectric RFID tag may generate its own unique signal such that it can be used to identify a particular product and provide corresponding product information. In an implementation, the piezoelectric RFID tag may be powered by a piezoelectric film.

For example, power may be generated through a piezoelectric film attached to an RFID tag. The film may be constructed from a diverse set of materials, including, but not limited to, man-made polymers such as polyvinylidene fluoride (PVDF), various naturally occurring and synthetic crystals, ceramics, and biological matter. Mechanical stress, such as that generated by movement, may cause deformation of the crystalline structure of the piezoelectric material. At an atomic level, this deformation may cause a change of electrical potentials which may be harvested as power and used in various solutions, much like a battery. This change may be used to power an internal transmitter of the RFID tag to transmit radio signals which an RFID reader may be listening for. Traditional active RFID tag may be powered by a conventional battery or power source.

Further automated checkout process 10 may receive (204) at a RFID reader (e.g., RFID reader 318, 320, 324, or 328), the signal (e.g., signal 308a, 310a, or 312a) from the piezoelectric RFID tag (e.g., piezoelectric RFID tags 308, 310, or 312), including the merchandise item information. In an implementation, one or more of RFID readers 318, 320, 324, and/or 328 may be passive RFID readers. The passive RFID readers described in the present disclosure may not transmit a power pulse as in a traditional passive RFID tag situation. The passive RFID tags described herein may listen to a specific frequency transmitted by the piezoelectric RFID tags. As such, these passive RFID tags may require fewer internal components and may be capable of longer-range operation than in a traditional passive tag system.

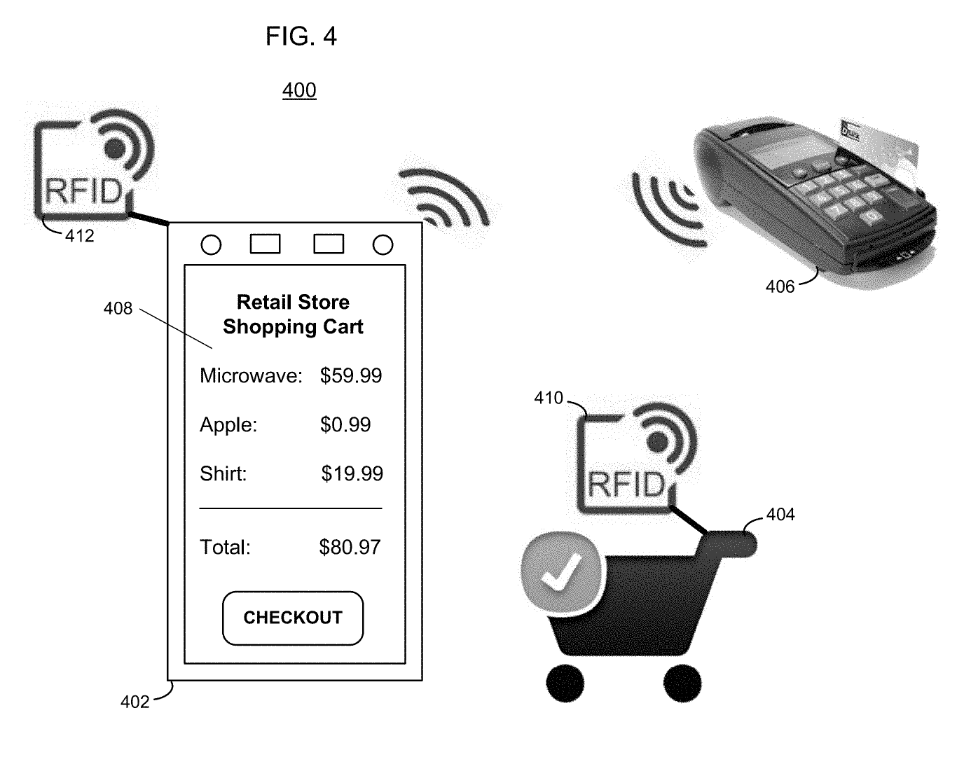

Additionally, automated checkout process 10 may determine (206), based on detection of the signal (e.g., signal 308a, 310a, or 312a) from the piezoelectric RFID tag (e.g., piezoelectric RFID tags 308, 310, or 312) including the merchandise item information at the passive RFID reader (e.g., RFID reader 318, 320, 324, or 328), whether the merchandise item should be added to an electronic shopping cart. Referring now also to FIG. 4, a smartphone 402, shopping cart 404 and point of sale device 406 are shown in an example system 400 which may be a point of sale environment. Smartphone 402 may run a retail store application or other application which may communicate with, coordinate with, or be executed as part of automated checkout process 10 and/or automated checkout processes 12, 14, 16, and/or 18. Smartphone 402 may display electronic shopping cart 408, which may keep track of merchandise items or products picked up by a shopper and carried in, for example, a physical shopping cart (e.g., shopping carts 314 or 404), shopping basket 316, or by hand. Electronic shopping cart 408 may be a component of a mobile application running on a mobile device such as smartphone 402.

For example, if a customer picks up product 306 and places it in a physical shopping cart (e.g., shopping carts 314 or 404), piezoelectric RFID tag 312 may be activated and may transmit signal 312a. An RFID reader (e.g., RFID reader 318 or 410) may receive signal 312a (including, e.g., merchandize item information about product 306) and provide information about signal 312a (e.g., signal strength, etc.) to a device running automated checkout process 10 and/or automated checkout processes 12, 14, 16, and/or 18.

Automated checkout process 10, may, for example, determine whether product 306 should be added to electronic shopping cart 408 based on signal 312a and/or signal information associated with signal 312a. For example, automated checkout process 10 may, in response to determining that the merchandise item (e.g., product 302, 304, and/or 306) should be added to the electronic shopping cart (e.g., based on signal 308a, 310a, and/or 312a), add (208) the merchandise item (e.g., product 302, 304, and/or 306) to electronic shopping cart 408 based on the merchandise item information. The merchandise item information may be associated with one or more of products 302, 304, 306 and may include a product code or number, price, or other product information. As shown in electronic shopping cart 408, automated checkout process 10 may add product 302 (e.g., a microwave), product 304 (e.g., an apple), and/or product 306 (a shirt) to electronic shopping cart 408 and may include merchandise item information associated with those products, such as the product code or number, price, or other product information.

In an implementation, when a customer places a merchandise item or product (e.g., product 302, 304, and/or 306) in a shopping cart (e.g., shopping carts 314 or 404) or shopping basket (e.g., shopping basket 316), the product may be added to and kept in an electronic shopping cart (e.g., electronic shopping cart 408). Automated checkout process 10 and/or an RFID reader (e.g., RFID reader 318, 320, 324, or 328) associated with the shopping cart or shopping basket may monitor RFID signals (e.g., signals 308a, 310a, or 312a) transmitted from RFID tags (e.g., piezoelectric RFID tags 308, 310, or 312) coupled to the products and determine if the products are still in the cart or shopping basket. This determination may be based on the signals received from the RFID tags at the RFID reader, including the strength of the signals.

For example, the RFID readers or passive RFID readers (e.g., RFID reader 318, 320, 324, or 328) may be arranged to detect RFID signals (e.g., signals 308a, 310a, or 312a) within a shopping cart and/or a shopping basket based on an RFID or passive RFID reader parameter. For example, if the customer places the product (e.g., product 302, 304, and/or 306) back on shelf or rack or otherwise away from the shopping cart or basket, the corresponding signal (e.g., signals 308a, 310a, or 312a) may no longer be transmitted and the product may be removed from the electronic shopping cart. In an implementation, automated checkout process 10 may determine if the products are still in the cart or shopping basket based on telemetry information in the RFID signals, as well as signal strength of RFID signals received or the use of a cage of RFID readers around a perimeter of the cart or basket.

In this way, automated checkout process 10 may determine (210), based on a change in detection of the signal (e.g., signals 308a, 310a, or 312a) from the piezoelectric RFID tag (e.g., piezoelectric RFID tags 308, 310, or 312) at the passive RFID reader (e.g., RFID reader 318, 320, 324, or 328), whether the merchandise item (e.g., product 302, 304, and/or 306) should be removed from electronic shopping cart 408. For example, if one or more of signals 308a, 310a, or 312a are no longer detected (for, e.g., a defined time period) by the RFID reader (e.g., RFID reader 318, 320, 324, or 328), the corresponding merchandise item or product may be removed from electronic shopping cart 408. As a result, automated checkout process 10 may, in response to determining that the merchandise item (e.g., product 302, 304, and/or 306) should be removed from electronic shopping cart 408, removing (212) the merchandise item (e.g., product 302, 304, and/or 306) from electronic shopping cart 408. Using the techniques and features described in the present disclosure, automated checkout process 10 may monitoring (214) content of electronic shopping cart 408 to determine whether a plurality of merchandise items (e.g., product 302, 304, and/or 306) coupled to piezoelectric RFID tags (e.g., piezoelectric RFID tags 308, 310, or 312) should be added or removed from electronic shopping cart 408 based on detection of signals from the piezoelectric RFID tags (e.g., piezoelectric RFID tags 308, 310, or 312).

A customer may add one or more merchandise items or products to a shopping cart or shopping basket or even carry the products around by hand and may ultimately wish to purchase the products which may have been added to the electronic shopping cart as described above. Automated checkout process 10 may conclude (216) a transaction for the merchandise item or products based on the electronic shopping cart. For example, electronic shopping cart 408 may include one or more of products 302, 304, 306 and may display price information for those products. An application displaying electronic shopping cart 408 and/or automated checkout process 10 may add the prices of each item in the electronic shopping cart and provide a total to be paid by the customer in exchange for the products.

In an implementation, the total may be paid via an application running on the mobile device through a credit card account or other customer account associated with the application. For example, once the customer indicates that it is time to check-out or once automated checkout process 10 determines that it is time to check-out, automated checkout process 10 may apply a credit card or apply funds from the customer account associated with the application to the total and complete the purchase or transaction. In this way, automated checkout process 10 may be conclude the transaction by deducting credit from a customer account associated with the application or with electronic shopping cart.

Further, in an implementation, automated checkout process 10 may transmit the total from the mobile device to point of sale device 406 which may be located at a check-out location or point of sale environment near the exit or a retail store or business. The customer may use point of sale device 406 to swipe a credit card or otherwise apply funds (e.g., cash, check, etc.) depending on the sophistication of point of sale device 406, which may be able to accept cash and provide change on an automated basis. The point of sale device and/or point of same environment may be or may include a mobile self-checkout system which may be operable to receive transaction data (e.g., prices, total prices, electronic shopping cart data, etc.) from the device (e.g., mobile device 402) having or maintaining the electronic shopping cart for the purpose of facilitating automated checkout.

In an implementation, the point of sale device may be a traditional register in a traditional point of sale environment in which an associate or employee of a retail store concludes the transaction for the customer.

In an implementation, the electronic shopping cart may not be displayed on a mobile device application or be associated with the mobile device application, or even if the electronic shopping cart is displayed on a mobile device application or is associated with the mobile device application, the electronic shopping cart may be kept by a computing device associated with or in communication with the RFID reader (e.g., one or more of RFID readers 318, 320, 324, 328, and/or 410) or by a server computer (e.g., server computer 20) in communication with the RFID reader. For example, one or more of RFID readers 318, 320, 324, 328, and/or 410 may transmit signal information associated with one or more of signals 308a, 310a, and/or 312a to the computing device (which may be coupled to a shopping cart, shopping basket, or wearable item or to the RFID reader itself) such that the computing device can maintain the electronic shopping cart as described above. For example, RFID reader 410 or a computing device associated therewith may transmit the electronic shopping cart and/or total to point of sale device 406 or to mobile device 402 such that the transaction can be completed as described above.

In an implementation, automated checkout process 10 may conclude 216 the transaction in response to determining that a customer associated with the electronic shopping cart has left a store or business. For example, the customer may carry mobile device 402 while shopping at the store, acquire items as shown in electronic shopping cart 408, and proceed to leave the store with the items. Automated checkout process 10 may determine, using one or more signals (e.g., GPS, Wi-Fi, NFC, Bluetooth, RFID signals, etc.) that the customer has left the store with mobile device 402, and infer that the customer has left with the products in electronic shopping cart 408 as well. In response to determining that the customer has left the store business, automated checkout process 10 may conclude the transaction via the mobile device or via an application running on the mobile device, as described above.

Using the techniques and features described herein for facilitating automated checkout, a customer may enter a business or retail store, pickup one or more products that he or she wishes to purchase, exit the store, and purchase the products without having to interact with a store employee or associate or without having to go through a check-out point or line. For, example, automated checkout process 10 may determine, at a computing device, that a customer having a retail store mobile application account has entered a retail store based on a signal received from a mobile device (e.g., signals (e.g., GPS, Wi-Fi, NFC, Bluetooth, RFID signals, etc.). Further, automated checkout process 10 may determine whether a merchandise item or product should be added to an electronic shopping cart associated with the retail store mobile application account (e.g., using piezo-electric RFID tags and RFID readers as described above). For example, determining whether the merchandise item or products should be added to the electronic shopping cart may include receiving, at a passive RFID reader, a signal from a piezoelectric RFID tag coupled to the merchandise item. Additionally, automated checkout process 10 may, in response to determining that the merchandise item should be added to the electronic shopping cart, add, at the computing device, the merchandise item to the electronic shopping cart. Automated checkout process 10 may additionally determine, at the computing device, that the customer having the retail store mobile application account has left the retail store based on a change in the signal received from the mobile device (e.g., based on one or more of GPS, Wi-Fi, NFC, Bluetooth, RFID signals, etc.). Moreover, automated checkout process 10 may, in response to determining that the customer has left the retail store, conclude a transaction for the merchandise item or products based on the electronic shopping cart. In this way, the systems and methods described in the present disclosure may be implemented such that a customer may enter a business or retail store, pickup one or more products that he or she wishes to purchase, exit the store, and purchase the products without having to interact with a store employee or associate or without having to go through a check-out point or line.

As described above, the techniques and features described in the present disclosure may facilitate automated checkout for a customer at a business or retail store. Using the techniques and features described in the present disclosure, the retailer may implement a system for automated checkout to improve efficiency, increase the speed with which customers may purchase items, and reduce costs by having less employees and computer or point of sale equipment for checkout purposes.

### Package Tracking Process

For the following discussion, server-side package tracking process 10a will be described for illustrative purposes. It should be noted that server-side package tracking process 10a may interact with client-side package tracking process 12a and may be executed within one or more applications that allow for communication with client-side package tracking process 12a. However, this is not intended to be a limitation of this disclosure, as other configurations are possible (e.g., stand-alone, client-side package tracking processes and/or stand-alone server-side package tracking processes). For example, some implementations may include one or more of client-side package tracking processes 12a, 14a, 16a, and/or 18a in place of or in addition to server-side package tracking process 10a. Further, all or parts of package tracking process 10a and/or package tracking processes 12a, 14a, 16a, and/or 18a may be run or executed in a point of sale environments.

As discussed above RFID tags may require batteries and power which may be costly. Prices associated with individual RFID tags powered with batteries or even passively powered may very expensive due to those power sources or corresponding RFID readers. Piezoelectric RFID tags may be much cheaper because they may not require batteries and may utilize piezoelectric power sources such as piezoelectric films. By coupling piezoelectric RFID tags with packages shipped to and received at a warehouse area or backroom of a retail store or distribution center, various issues associated with RFID tagging everything in the warehouse area or backroom of the retail store or distribution center (e.g., too many signals being transmitted at the same time, RFID readers receiving too many signals, battery cost, etc.) may be avoided and package tracking may be facilitated while decreasing costs.

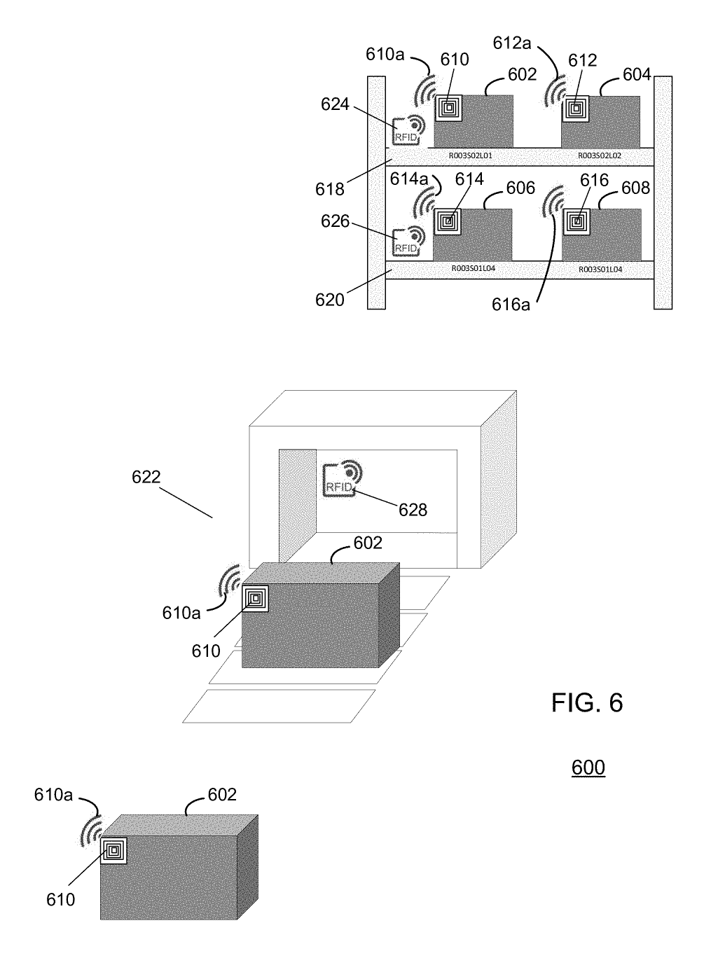

Referring now to FIG. 6, example components of a system 600 for facilitating package tracking are shown. For example, packages 602, 604, 606 and 608 may be coupled to piezoelectric RFID tags 610, 612, 614, and 616, respectively. As discussed above, piezoelectric RFID tags 602, 604, 606 and 608 may be powered in response to movement. Passive RFID readers may be coupled to or may sit on shelves 618 and/or 620, and/or conveyor belt system 622, among other objects. For example, shelves 618 and/or 620 may be coupled to or associated with RFID readers 624 and 626, respectively. Conveyer belt 622 may be coupled to or associated with RFID reader 628. One or more of the passive RFID readers may be coupled to a computing device having a package tracking component or application. Further, one or more of the passive RFID readers may be arranged to detect a signal from one or more of piezoelectric RFID tags 610, 612, 614, and 616, coupled to packages 602, 604, 606 and 608, respectively.

In this way, system 600 may include a plurality of piezoelectric RFID tags (e.g., piezoelectric RFID tags 610, 612, 614, and 616) and a plurality of packages (e.g., packages 602, 604, 606 and 608). Each of the plurality of piezoelectric RFID tags may be coupled to a different one of the plurality of packages in a one to one correspondence and may be powered in response to movement. The packages and components shown in FIG. 6 may be part of an example warehousing or backroom storage environment at a retail store or distribution center which implements example system 600 and the techniques and features described in the present disclosure to facilitate package tracking. In an implementation, hundreds or thousands of packages in a store or business (e.g., a retail store or distribution center) may be coupled with piezo-electronic RFID tags to facilitate package tracking as described herein.

Referring also to FIG. 5, in an embodiment, methods for facilitating package tracking may be provided and may be implemented via package tracking process 10a. In an embodiment, package tracking process 10a may, in response to activation of a piezoelectric RFID tag (e.g., piezoelectric RFID tags piezoelectric RFID tags 610, 612, 614, or 616) coupled to a customer order package (e.g., packages 602, 604, 606 or 608), transmit (502) a signal from the piezoelectric RFID tag. The signal (e.g., signal 610a, 612a, 614a, or 616a) may be an RFID signal and may include customer order information about a product in the package or the package itself, such as a product codes or numbers, prices, order date, name of the purchaser, purchaser address, etc. For example, if a package 602 is moved by an employee from a truck into a warehouse area, onto conveyer 622, or onto shelf 624, piezoelectric RFID tag 602 may be activated and may transmit RFID signal 610a (which may include customer order information).

It should be noted that use of piezoelectric RFID tags 610, 612, 614, or 616 or other piezo-electrically powered RFID tags rather than active or even some passive RFID tags on multiple packages (in, e.g., a retail store warehouse environment) may avoid the situation where multiple RFID signals are constantly sent in the warehouse environment. By using piezo-electrically powered RFID tags, corresponding RFID signals may only be transmitted when the packages (and RFID tags coupled thereto) are moved. Each piezoelectric RFID tag may generate its own unique signal such that it can be used to identify a particular customer order package or other package and provide corresponding product/package information. In an implementation, the piezoelectric RFID tag may be powered by a piezoelectric film, such as those described above.

Further package tracking process 10a may receive (504) at a RFID reader (e.g., RFID reader 624, 626, or 628), the signal (e.g., signals 610a, 612a, 614a, or 616a) from the piezoelectric RFID tag (e.g., piezoelectric RFID tags 610, 612, 614, or 616), including the customer order information. In an implementation, one or more of RFID readers 624, 626, and/or 628 may be passive RFID reader or semi-passive RFID reader, such as those described above. The RFID reader may be positioned in the retail store, distribution center, or warehouse, to provide a location status of the customer order package (e.g., packages 602, 604, 606 and/or 608) to the customer order package server (e.g., server computer 20) in response to receiving a signal (e.g., signals 610a, 612a, 614a, or 616a) from the piezoelectric RFID tag (e.g., piezoelectric RFID tags 610, 612, 614, or 616) coupled to the customer order package.

Package tracking process 10a may also log (506), based on receiving of the signal (e.g., signals 610a, 612a, 614a, or 616a) from the piezoelectric RFID tag (e.g., piezoelectric RFID tags 610, 612, 614, or 616) at the RFID reader (e.g., RFID reader 624, 626, or 628), the customer order package (e.g., packages 602, 604, 606 or 608) as having an arrived status at a customer order package server (e.g., server computer 20) in communication with the RFID reader (e.g., RFID reader 624, 626, or 628). For example, if a package 602 is moved by an employee from a truck into a warehouse area of a retail store or distribution center, an RFID reader at entrance of the warehouse or associated with conveyor 622 such as RFID reader 628 may receive signal 610a from piezoelectric RFID tag 610. RFID reader 628 may be in communication with server computer 20 which may run or execute package tracking process 10a which may log package 602 as having arrived at the warehouse area or at the retail store or distribution center. In an implementation, the arrival status of the package may be logged into a package logging system which stores a location and/or status or multiple packages and is viewable by an employee or associate or a retail store or business to locate a particular package for retrieval, and to provide the package to a customer.

In response to logging the customer order package (e.g., packages 602, 604, 606 or 608) as having the arrived status at the customer order package server, package tracking process 10a may transmit (508) a customer order notification to a customer associated with the customer order information. The customer order notification may indicate that the customer order package has arrived at the retail store. The customer order notification may be transmitted to a mobile device or other client electronic device associated with the customer. For example, server computer 20, which may run or execute package tracking process 10a which may log package 602, may transmit the customer order notification to one or more of client electronic devices 28, 30, 32, and/or 34, where one or more of users 44, 46, 48, and/or 50 may receive the customer order notification. In an implementation, one or more of the RFID readers may be arranged to detect RFID signals reaching a geo-fence of the retail store. For example, RFID readers may be places around entrances the retail store such that when a package equipped with an RFID tag moves near an entrance of the retail store, the corresponding RFID signal is received and package tracking process 10a may log the status of the package as having arrived at the retail store.

In an implementation, package tracking process 10a may log (510) a location status for the customer order package (e.g., packages 602, 604, 606 or 608) at the customer order package server (e.g., server computer 20) in communication with the RFID reader based (e.g., RFID reader 624, 626, or 628) on a location of the RFID reader. For example, RFID reader 628 may be associated with conveyor 622 which may be located at or near an entrance of a warehouse or backroom area of a retail store or distribution center. After receiving signal 610a from RFID tag 610, RFID reader 628 may indicate to server computer 620 (e.g., via package tracking process 10a) that signal 610 was received and, based on the location of RFID reader 628, package tracking process 10a may log the location status for package 602 as the warehouse.

Further, package tracking process 10a may update (512) the location status for the customer order package (e.g., packages 602, 604, 606 or 608) at the customer order package server (e.g., server computer 20) in response to receiving the signal (e.g., signals 610a, 612a, 614a, or 616a) including the customer order information at another RFID reader (e.g., RFID reader 624, or 626) at the retail store, based on a location of the other RFID reader (e.g., RFID reader 624, or 626). For example, an employee or associate or the retail store may place package 602 on shelf 618, which may be in a warehouse or backroom area of the retail store or distribution center. Shelf 618 may also be located in an area designated for keeping packages waiting to be picked up by customers at the retail store or distribution center. As such, package tracking process 10a may update the location status for package 602 at the customer order package server (e.g., server computer 20) in response to receiving signals 610a at RFID reader 624 associated with shelf 618. The location status for package 602 may be updated to shelf 618, or to the designated package waiting area or other area where shelf 618 is located, based on a location of RFID reader 624.

In an implementation, package tracking process 10a may monitor (514), via a plurality of RFID readers (e.g., RFID reader 624, 626, 628) at the retail store or business, changes in location of the customer order package (e.g., packages 602, 604, 606 or 608) by receiving the signal (e.g., signals 610a, 612a, 614a, or 616a) including the customer order information at the plurality of RFID readers and logging a location status for the customer order package at the customer order package server (e.g., server computer 20) based on a location of each of the plurality of RFID readers at the retail store. The changes in location of the packages may be logged such that a location status of each of the packages is up to date. The location status for the customer order package at the customer order package server may indicate a shelf location (e.g., shelves 624 or 626) of the customer order package in the retail store or business.

Package tracking process 10a may also transmit (516) the location status for the customer order package (e.g., packages 602, 604, 606 or 608) from the customer order package server (e.g., server computer 20) to a point of sale system at the retail store. The location status for the customer order package (e.g., packages 602, 604, 606 or 608) may be based on the location (e.g., shelf 618, 620) of the last RFID reader (e.g., RFID reader 624, 626) to receive a signal (e.g., signals 610a, 612a, 614a, or 616a) from the RFID tag (e.g., piezoelectric RFID tags 610, 612, 614, or 616) coupled to the package. For example, a customer may appear at the retail store or business to pick up a previously ordered product, which was packaged and shipped to the retail store. An employee or associate of the retail store may assist the customer at a point of sale system, such as a computer implemented register or other check-out device, which may be in communication with the customer order package server (e.g., server computer 20) and may receive package logging information from the customer order package server. The employee or associate may access the logging information from the point of same device, determine a location status for the particular product/package that the customer intends to pick up, and retrieve the package for the customer.

Using the techniques and features described in the present disclosure, a plurality of RFID readers at the retail store or distribution center may be positioned to monitor changes in location of customer order packages by receiving signals including customer order information from piezoelectric RFID tags coupled to the customer order packages at the plurality of RFID readers. The plurality of RFID readers may transmit location statuses for the customer order packages to the customer order package server based on locations of each of the plurality of RFID readers at the retail store or distribution center. In this way, a retail store or business may implement a system for tracking customer order packages including a plurality of piezoelectric RFID tags to monitor locations of a plurality of customer order packages, where each of the plurality of piezoelectric RFID tags may be coupled to a different one of the plurality of customer order packages in a one to one correspondence and may be powered in response to movement.

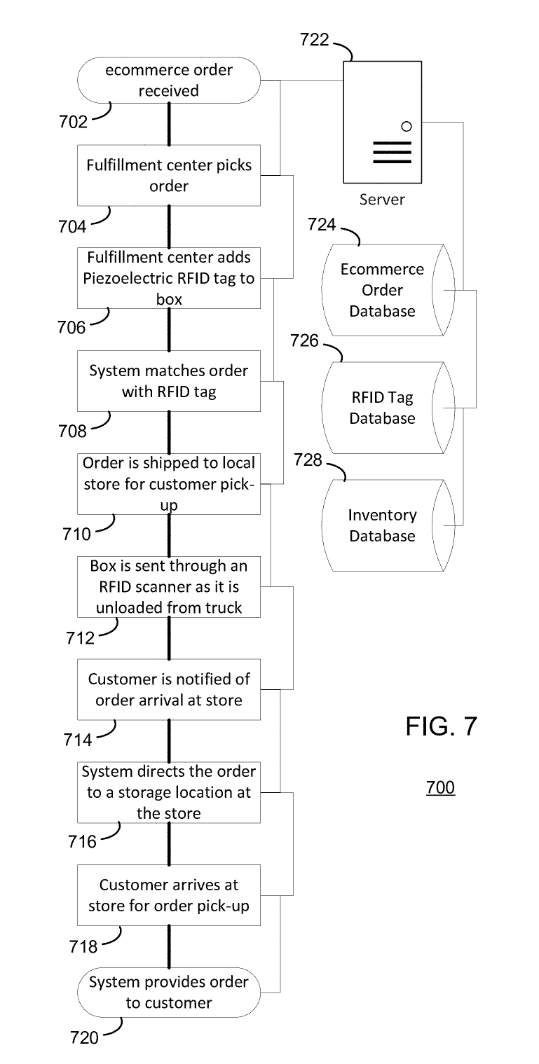

Referring now to FIG. 7, an example process 700 for package tracking is shown. Process 700 may operate or may be implemented via package tracking process 10a, which may perform some or all of the operations of process 700. In an implementation, an ecommerce order may be received (702) at a server 722, which may be an ecommerce server or may be server computer 20, as discussed above. The ecommerce order may be logged or maintained at an ecommerce order database 724 in communication with server 22. A fulfillment center operation may pick (704) the order, which may include acquiring the item or product ordered and boxing the item. A fulfillment center operation may also add (706) or couple a piezoelectric RFID tag to a box or package including the product ordered. A system or process (e.g., via package tracking process 10a) may match (708) the order with the piezoelectric RFID tag coupled to the package. The RFID tag information and corresponding package information may be logged or maintained at an RFID tag database 726, which may also be in communication with server computer 722. The information may also be logged or maintained (at least in part) at an inventor database 728.

Further, the order/package/box may be shipped (710) to a local store or local retail store or pick up center for customer pick-up. The box may be sent (712) through an RFID reader or scanner as it is unloaded from a truck. The customer may be notified (714) (e.g., as described above) of the arrival of the order/package/box at the local store. The system or process (e.g., via package tracking process 10a) may direct (716) the order/package/box to a store location (e.g., a shelf location) at the location store. The customer may arrive at the store for order pick-up (718) and the system or process may provide (720) the order/package/box to the customer (e.g., a store employee may retrieve and provide the order/package/box to the customer).

As described above, the techniques and features described in the present disclosure may facilitate package tracking at a business or retail store. Using the techniques and features described in the present disclosure, the retailer or business may implement a system for package tracking to improve efficiency, increase the speed with which customers may purchase items and retrieve items online, and reduce costs by having less employees and computers or point of sale equipment.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

Implementations of the present disclosure and all of the functional operations provided herein can be realized in digital electronic circuitry, or in computer software, firmware, or hardware, including the structures disclosed in this specification and their structural equivalents, or in combinations of one or more of them. Implementations of the disclosure can be realized as one or more computer program products, i.e., one or more modules of computer program instructions encoded on a computer readable medium for execution by, or to control the operation of, a data processing apparatus. The computer readable medium can be a machine-readable storage device, a machine readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions or computer program products and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. These may also be referred to as computer readable storage media. The processor and the memory can be supplemented by, or incorporated in, special purpose logic circuitry.

To provide for interaction with a user, implementations of described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations of the present disclosure can be realized in a computing system that includes a back end component, e.g., as a data server, or that includes a middleware component, e.g., an application server, or that includes a front end component, e.g., a client computer having a graphical user interface or a Web browser through which a user can interact with an implementation of the present disclosure, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this disclosure contains many specifics, these should not be construed as limitations on the scope of the disclosure or of what may be claimed, but rather as descriptions of features specific to particular implementations of the disclosure. Certain features that are described in this disclosure in the context of separate implementations can also be provided in combination in a single implementation. Conversely, various features that are described in the context of a single implementation can also be provided in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

A number of embodiments and implementations have been described. Nevertheless, it will be understood that various modifications may be made. Accordingly, other embodiments and implementations are within the scope of the following claims. For example, the actions recited in the claims can be performed in a different order and still achieve desirable results.

What is claimed is:

1. A method for tracking customer order packages, the method comprising:
in response to activation of a piezoelectric RFID tag coupled to a customer order package, transmitting a signal from the piezoelectric RFID tag, the signal including customer order information;
receiving, at a first RFID reader at a retail store, the signal from the piezoelectric RFID tag including the customer order information;
logging, based on receiving of the signal from the piezoelectric RFID tag at the first RFID reader, the customer order package as having an arrived status at a customer order package server in communication with the first RFID reader; and
in response to logging the customer order package as having the arrived status at the customer order package server, transmitting a customer order notification to a customer associated with the customer order information indicating that the customer order package arrived at the retail store.

2. The method of claim 1, further comprising:
logging a location status for the customer order package at the customer order package server in communication with the first RFID reader based on a location of the first RFID reader.

3. The method of claim 2, further comprising:
updating the location status for the customer order package at the customer order package server in response to receiving the signal including the customer order information at a second RFID reader at the retail store, based on a location of the second RFID reader.

4. The method of claim 1, wherein the piezoelectric RFID tag is powered by a piezoelectric film.

5. The method of claim 1, wherein the first RFID reader is at least one of a passive RFID reader and a semi-passive RFID reader.

6. The method of claim 1, wherein the first RFID reader is arranged to detect RFID signals reaching a geo-fence of the retail store.

7. The method of claim 1, further comprising:
monitoring, via a plurality of RFID readers at the retail store, changes in location of the customer order package by receiving the signal including the customer order information at the plurality of RFID readers and logging a location status for the customer order package at the customer order package server based on a location of each of the plurality of RFID readers at the retail store.

8. The method of claim 2, wherein the location status for the customer order package at the customer order package server indicates a shelf location of the customer order package in the retail store.

9. The method of claim 1, wherein the customer order notification is transmitted to a mobile device associated with the customer.

10. The method of claim 3, further comprising:
transmitting the location status for the customer order package from the customer order package server to a point of sale system at the retail store, the location status for the customer order package based on the location of the second RFID reader.

11. A system for tracking customer order packages, the system comprising:
a piezoelectric RFID tag coupled to a customer order package and powered in response to movement;
a RFID reader at a retail store in communication with a customer order package server; and
wherein the RFID reader is positioned in the retail store to provide a location status of the customer order package to the customer order package server in response to receiving a signal from the piezoelectric RFID tag coupled to the customer order package.

12. The system of claim 11, wherein the piezoelectric RFID tag is powered by a piezoelectric film.

13. The system of claim 11, wherein the RFID reader is at least one of a passive RFID reader and a semi-passive RFID reader.

14. The system of claim 11, wherein the RFID reader is arranged to detect RFID signals reaching a geo-fence of the retail store.

15. The system of claim 11, further comprising:
a plurality of RFID readers at the retail store positioned to monitor changes in location of the customer order package by receiving a signal including customer order information from the piezoelectric RFID tag coupled to the customer order package at the plurality of RFID readers and transmit a location status for the customer order package to the customer order package server based on a location of each of the plurality of RFID readers at the retail store.

16. The system of claim 11, further comprising:
a point of sale system in communication with the customer order package server positioned to receive the location status of the customer order package from the customer order package server, the location status for the customer order package based on the location of the RFID reader.

17. A system for tracking customer order packages, the system comprising:
a plurality of piezoelectric RFID tags and a plurality of customer order packages, each of the plurality of piezoelectric RFID tags coupled to a different one of the plurality of customer order packages in a one to one correspondence and powered in response to movement;
a plurality RFID readers at the retail store positioned to monitor changes in location of the plurality of customer order packages by receiving signals including customer order information from each of the plurality of piezoelectric RFID tags coupled to the different customer order packages at the plurality of RFID readers and transmit location statuses for the customer order packages to the customer order package server based on locations of each of the plurality of RFID readers at the retail store; and
a point of sale system in communication with the customer order package server positioned to receive the location statuses of the customer order packages from the customer order package server, the location statuses for the customer order packages based on the locations of each of the plurality of RFID readers at the retail store.

18. The system of claim 17, wherein at least one of the piezoelectric RFID tags is powered by a piezoelectric film.

19. The system of claim 17, wherein at least one of the RFID readers is at least one of a passive RFID reader and a semi-passive RFID reader.

20. The system of claim 17, wherein at least one of the RFID readers is arranged to detect RFID signals reaching a geo-fence of the retail store.
